(19) United States
(12) Patent Application Publication
(10) Pub. No.: US 2007/0078719 A1
(43) Pub. Date: Apr. 5, 2007

(54) S/M for offering reward programs

(75) Inventors: Donald H. Schmitt, Greenville, DE (US); Brian S. Gantert, Hockessin, DE (US); Elizabeth Gula, Lincoln University, PA (US); Douglas A. Filak, Hockessin, DE (US); Stacy M. Hamilton, Avondale, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: JP Morgan Chase Bank, New York, NY (US)

(21) Appl. No.: 11/634,159

(22) Filed: Dec. 6, 2006

Related U.S. Application Data
(63) Continuation-in-part of application No. 10/284,394, filed on Oct. 31, 2002.
(60) Provisional application No. 60/330,871, filed on Nov. 1, 2001.
(60) Provisional application No. 60/822,609, filed on Aug. 16, 2006.

(51) Int. Cl. G06Q 30/00

(52) U.S. Cl. 705/14

(57) ABSTRACT

A system and method for identifying and offering reward programs. The method comprises the step of determining at least one rewards program associated with a user. The next step involves determining the user's transaction history or reward program history with a first reward card associated with the rewards program. Then, the method determines at least one alternative reward programs to offer the user based on the user's transaction history or reward program history, and the offering the user the opportunity to enroll in the alternative rewards program. Next, the method converts rewards associated with the at least one rewards program to rewards associated with the at least one alternative reward program if the user accepts the offer to enroll.

### RELATED APPLICATION

This application is a continuation-in-part of co-pending U.S. patent application Ser. No. 10/284,394 filed Oct. 31, 2002, titled “System and Method for Establishing or Modifying and Account with User Selectable Terms,” which claims priority to U.S. Provisional Application Ser. No. 60/330,871, filed Nov. 1, 2001, titled “System and Method for Establishing or Modifying an Account with User Selectable Terms.” The present application also claims priority to U.S. Provisional Application No. 60/822,609, filed on Aug. 16, 2006, and titled “System and Method for Offering Reward Programs.” The specification and drawings of each of the above applications is incorporated herein by reference in their entirety.

### FIELD OF THE INVENTION

The present invention relates to the identification and offering of reward programs. More particularly, the present invention relates to systems and methods that enable card issuers or sponsors, for example, to identify and offer its customers relevant reward programs based on customer transaction, reward program history (e.g., redemption history, reward earnings history, earning levels, reward categories, currency type (e.g., points, miles or cash), or any other particular related to a reward program), currency, customer responses to questions, and/or other data or information that enables identification of relevant and reward programs.

### BACKGROUND

Rewards programs are becoming increasingly popular. Card issuers, such as banks, for example, commonly offer their customers reward cards (e.g., credit cards, debit cards, stored value cards, or gift cards) that are associated with particular reward programs that aim to encourage or induce customer use by rewarding all or select transactions rewards are typically based on any number of transaction particulars, such as spending levels, types of transaction, identity of merchant or vendor, location of transactions, or any other data or information that demonstrates user behavior. For example, a card issuer may provide incentives (e.g., rebates or discounts) on purchases made through a particular vendor or merchant rewards may also include cash-back deals where the customer earns a percentage of the transaction amounts as cash value that gets added to the card member's account.

In some cases, reward cards may be “branded” with the name of a particular sponsor or merchant so that use of the card earns the customer points that may be redeemed through the sponsor or merchant. For example, a credit card sponsored by an airline may reward the user with airline miles that may be redeemed for free or discounted travel. Likewise, some cards earn store dollars that can be used as virtual cash to make purchases through select merchants and vendors.

Although conventional systems and methods enable card-issuers and sponsors to provide customers with a wide variety of reward programs, they nonetheless suffer from several notable drawbacks. For example, current systems and methods do not enable card-issuers and sponsors to dynamically identify and offer card members with relevant reward programs on an ongoing basis. Existing systems and methods depend primarily on mass mailings and other like marketing techniques to generate interest in rewards program. Once a card member subscribes to a particular reward program, there is no known system or technique for ensuring that reward programs remain relevant to the card member in the future, or for offering alternative reward programs should needs or circumstances change. As a result, many potential reward program marketing opportunities go unrealized resulting in diminished value for reward programs in general.

Thus, what is needed is a reward program system and method that enables a card issuer or sponsor to dynamically identify and offer card members relevant reward programs based on customer particulars, such as demonstrated customer transaction history and expressed customer interests and needs.

### SUMMARY OF THE INVENTION

According to various embodiments, the systems and methods described herein may allow card issuers, sponsors, or card members (including new prospects), for example, to evaluate or reevaluate card usage and thereafter switch to reward program(s) that are better suited to the card member's needs. For example, the various systems and methods described herein may be used by a card issuer, for example, to introduce a promotional called “15 minutes and save 15%” that enables a card member to call (or receive calls from) the card issuer in connection with alternative reward programs that may be of particular relevance or greater interest to the card member. In such a promotional, the various systems and methods described herein may the identify the card member's current reward program and determine particulars about the card member, such as, for example, biographical or demographic information about the card member and the card member's transaction history or reward program history (e.g., redemption history, reward earnings history, earning levels, reward categories, currency type (e.g., points, miles or cash), or any other particular related to a reward program) with the card to see if another rewards program may be preferred. For example, it may turn out that a card member having a card that rewards cash-back on purchases may frequently use the card in grocery stores. The various systems and methods described herein may then conduct a search of alternative reward programs and identify a rewards program that rewards the card member savings of 5% on all grocery purchases. The card member may then decide whether he or she prefers to get cash-back on purchases or switch to the alternative reward program and save 5% on all grocery transactions.

In some embodiments, alternative reward programs may be identified based on data or information on card members and card transactions, as well as a series of questions that the card member may be asked to enable a more granular assessment of needs. For example, if the card member calls into (or receives call from) a call center of the card issuer, for example, the card holder may be asked “You're a student, are you still enrolled in school?” If the card member answers “yes,” then the card member may be offered a reward that is affiliated with a particular sponsor that retails products and services of interest to currently enrolled students, such as discounts on purchases at a college bookstore, for example. Similarly, a card member that is a parent may be offered a sponsored or branded card that rewards points or other value that may be redeemed at particular theme parks, for example.

In some embodiments, the internal data and information may be presented to a call center operator along with a series of questions to ask the caller. The information request functionality of the various systems and methods described herein may be triggered in any number of interactions or dialogues with a card member. For example, the card member may be asked online (e.g., while making a payment, checking balance or simply browsing), during an in-bound or out-bound telephone call (e.g., while making a payment, checking balance, etc.), or via mailings (e.g., snail mail or email) or other advertisements. This functionality may also apply with card members of other sponsors or banks, for example. Thus, a card member having a MBNA card, for example, may be asked to “pause and consider” other preferred options with the Bank.

In some embodiments, the various systems and methods described herein may allow card members to switch between rewards programs without losing earned points/miles/cash or any rewards value. For example, if switching between a “cash back” card containing $12 to a “theme park” card, the $12 may be moved accordingly. Other kinds and forms of value (e.g., miles, points, widgets, or any other unit have value). In some embodiments, rewards value (e.g., points) may be transferred one-to-one or according to a predetermined or specified conversion rate. For example, a proprietary currency for a theme park card may be converted to a proprietary currency for retailer card (e.g., exchange or conversion rate). In some embodiments, the systems and methods described herein may transfer or convert value (e.g., points) between two different types of rewards programs, as distinguished between “universal” rewards value that effectively comprise merely a single rewards program. In some embodiments, value may be switched, converted or credited between different reward programs of a single rewards program entity, or between reward programs associated with different reward program entities. For example, the initial value may correspond to a rewards program administered by a first bank, while the switched-to value may correspond to a rewards program administered by a second bank. In some embodiments, credits may be provided to a customer rather than switching value types. For example, the customer may keep his or her rewards associated with the first bank, but the second bank may then offer the customer a card, for example, which is associated with a specified amount of credited rewards or value. In some embodiments, the credited rewards may be equivalent to the rewards of the first bank, while in some embodiments, the credited rewards may be more or less than the first bank rewards. In some embodiments, credited rewards may be determined according to certain rules or appropriate conversion rates.

The systems and methods described herein may also process rewards programs that are not points-based, such as a card where a percentage of money spent is applied to a college fund, for example, or a credit card allows one to have specified use privileges (e.g., use airline lounge for free). In this situation, an appropriate exchange rate may be applied in converting or changing the rewards program. Also, the card member need not lose or close out his or her initial card, only the rewards program may change. This way, the card member may still enjoy other particulars of the card, such as the minimum monthly payment or interest rate, for example.

According to one embodiment of the invention, a method for identifying and offering reward programs is provided. The method comprises the steps of: determining at least one rewards program associated with a user; determining at least one alternative reward program to offer the user based on the user's selection, demographics, responses to a questionnaire, transaction history, or reward program history; offering the user the opportunity to enroll in the alternative rewards program; and converting or crediting rewards associated with the at least one rewards program to rewards associated with the at least one alternative reward program if the user accepts the offer to the enroll.

In yet another embodiment of the invention, a method for identifying and offering reward programs is provided. The method comprises the steps of: determining at least one rewards program associated with a user; determining the user's transaction history or reward program history (e.g., redemption history, reward earnings history, earning levels, reward categories, currency type (e.g., points, miles or cash), or any other particular related to a reward program) with a first reward card associated with the rewards program; determining at least one alternative reward programs to offer the user based on the user's transaction history or reward program history (e.g., redemption history, reward earnings history, earning levels, reward categories, currency type (e.g., points, miles or cash), or any other particular related to a reward program); offering the user the opportunity to enroll in the alternative rewards program; and converting or crediting rewards associated with the at least one rewards program to rewards associated with the at least one alternative reward program if the user accepts the offer to enroll.

In another embodiment of the invention, a system for offering or marketing reward programs is provided. The system comprising a detection module for detecting user interaction with an issuer or sponsor of a rewards card; a rewards program module for determining at least one rewards program associated with the reward card or the user of the reward card; a customer history determination module for determining the user's transaction history or reward program history (e.g., redemption history, reward earnings history, earning levels, reward categories, currency type (e.g., points, miles or cash), or any other particular related to a reward program) with the rewards card; an rewards program evaluation module for determining at least one alternative reward programs to offer the user based on the user's transaction history or reward program history (e.g., redemption history, reward earnings history, earning levels, reward categories, currency type (e.g., points, miles or cash), or any other particular related to a reward program); and a conversion module for converting or crediting rewards associated with the at least one rewards program to rewards associated with the at least one alternative reward program if the user accepts an offer to the enroll in the alternative reward program, wherein the conversion is based on a conversion rate stored and maintained by a conversion rate module.

In yet another embodiment of the invention, a system for identifying and offering reward programs is provided. The system comprises a rewards program module for storing and administering particulars of a plurality of reward programs including at least one reward program associated with at least one customer; a customer module for storing and administering particulars of a plurality of customers including the at least one customer, wherein the at least one customer is associated with at least one reward card that is associated with the at least one reward program; a customer history module for tracking, storing and administering particulars of the at least one customer's transaction history or reward program history (e.g., redemption history, reward earnings history, earning levels, reward categories, currency type (e.g., points, miles or cash), or any other particular related to a reward program) with the at least one reward card; a questions module for storing and administering questions to ask the at least one customer, wherein the customer's responses to the questions are used to identify reward programs that are of interest to the customer; a rewards program evaluation module for determining at least one alternative reward program that may be of interest to the user based on biographical or demographic data or information about the customer, the customer's transaction history or reward program history (e.g., redemption history, reward earnings history, earning levels, reward categories, currency type (e.g., points, miles or cash), or any other particular related to a reward program) with the at least one reward card, or the customer's responses to the questions; and a conversion module for converting or crediting rewards associated with the at least one rewards program to rewards associated with the at least one alternative reward program if the user accepts an offer to the enroll in the alternative reward program, wherein the conversion is based on a conversion rate stored and maintained by a conversion rate module.

In another embodiment of the invention, a method for identifying and offering reward programs is provided. The method comprises the steps of: determining at least one rewards program associated with a user; determining at least one alternative reward program to offer the user based on an issuing entity's assessment of the user; offering the user the opportunity to enroll in the alternative rewards program; and converting or crediting rewards associated with the at least one rewards program to rewards associated with the at least one alternative reward program if the user accepts the offer to the enroll.

Other embodiments may also be considered.

### BRIEF DESCRIPTION OF THE DRAWINGS

FIG. 1 shows an exemplary system 100 for offering reward programs, according to various embodiments of the invention.

FIG. 2 illustrates various exemplary modules that may be associated with central rewards program station 105, according to various embodiments of the invention.

FIG. 2a illustrates a customer interaction detection module 250 that may be associated rewards program evaluation module 225 of FIG. 2, according to various embodiments of the invention.

FIG. 3 illustrates an exemplary process flow 300 for offering reward programs, according to various embodiments of the invention.

FIG. 4 illustrates an exemplary process flow 400 for converting value (e.g., points) associated with rewards programs, according to various embodiments of the invention.

FIG. 5 illustrates a process flow 500 for offering rewards programs, according to various embodiments of the invention.

FIG. 6 illustrates a process flow 600 for offering rewards programs, according to various embodiments of the invention.

FIG. 7 illustrates a process flow 700 for converting value (e.g., points) associated with rewards programs, according to various embodiments of the invention.

### DETAILED DESCRIPTION OF EXEMPLARY EMBODIMENTS

Reference will now be made to the present preferred embodiments of the invention, examples of which are illustrated in the accompanying drawings in which like reference characters refer to corresponding elements.

The present invention is described in relation to a system and method for identifying and offer reward programs. Nonetheless, the characteristics and parameters pertaining to the system and method may be applicable to transactions associated with other types of reward programs.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Among many potential uses, the systems and methods described herein may be used to: (1) induce customer loyalty by dynamically identifying and offering to customers relevant reward program offers based on customer behavior (e.g., past transactions), and other factors, such as, for example, favorite or repeat merchants, location of transactions, spending levels, biographical or demographic information, or any other data or information that may be used to particularize or focus offers of reward programs; (2) allow card members to efficiently switch between royalty programs, either through the same or different card; (3) allow issuers and sponsors, for example, to efficiently update and revise their affiliated reward programs; (4) allow conversion of rewards between different reward programs; (5) allow centralized coordination and offering of multiple reward programs; (6) track customer transactions and decision-making to enhance the resolution and precision of reward program offers; and (7) allow a third party (e.g., a bank or other financial institution) to administer and coordinate the offering of relevant reward program offers. Other uses are possible.

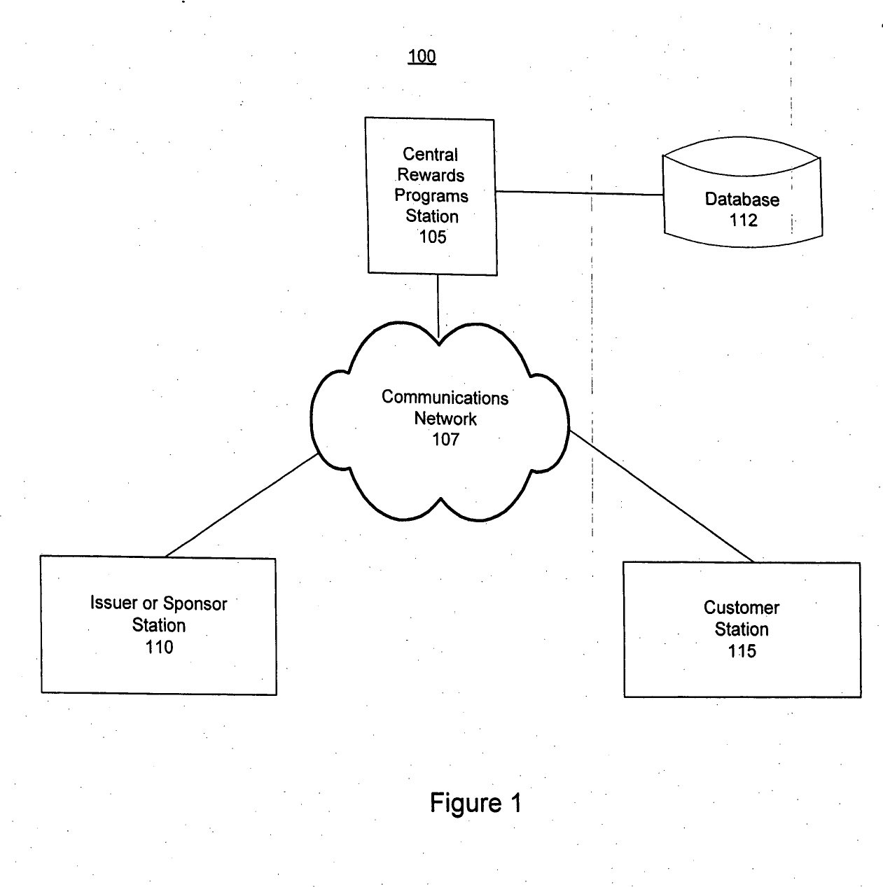

FIG. 1 illustrates a system 100 for offering reward programs according to one embodiment of the invention. System 100 may comprise a central reward program station 105 for identifying and offering reward programs based on customer (e.g., card member) particulars, such as past transactions and expressed interests and needs. In some embodiments, central rewards programs station 105 may be administered by a bank or financial institution that issues and administers cards (e.g., a card-issuer), a merchant or vendor that sponsors a reward program (e.g., a sponsor), or any third party that coordinates, manages or administers customer interaction with merchants 110 via cards and corresponding rewards programs. In some embodiments, central rewards programs station 105 may maintain particulars about card members, reward programs, sponsors, and any data and information that may be used to identify and offer reward programs according to the systems and methods described herein. In some embodiments, central rewards program station 105 may comprise the central headquarters or repository of the various features and functions of the systems and methods described herein, and may be maintained by any party or entity that administers the coordination of data and information in connection with the identification and offering of reward programs according to the systems and methods described herein.

Central rewards programs station 105 may comprise a single server or engine (as shown). In another embodiment, central rewards programs station 105 may comprise a plurality of servers or engines, dedicated or otherwise, which may further host modules for performing desired system functionality. Central rewards programs station 105, for example, may host one or more applications or modules that function to permit interaction between the users of system 100 (e.g., sponsors, customers, the administrator of central rewards programs station 105, and any other relevant parties) as it relates to exchanging and processing of data and information related to the identification and offering of reward programs, for example. For instance, central rewards programs station 105 may include an administration module that serves to permit interaction between the system 100 and the individual(s) or entity(ies) charged with administering system 100 or central rewards programs station 105. Such an administration module may enable the agent of central rewards programs station 105, for example, to input information related to royalty programs, including but not limited to parameters used to determine which reward programs to offer or present to a customer. Such parameters may comprise variables that define a particular pool or segment of customers that may be presented with a particular reward program. Thus, a reward program offering 10% discounts on groceries should be offered to card members that through past transactions demonstrate frequency of shopping for groceries using a card. This way, the reward program may be properly targeted and focused on card-members most inclined to appreciate and benefit from the reward program.

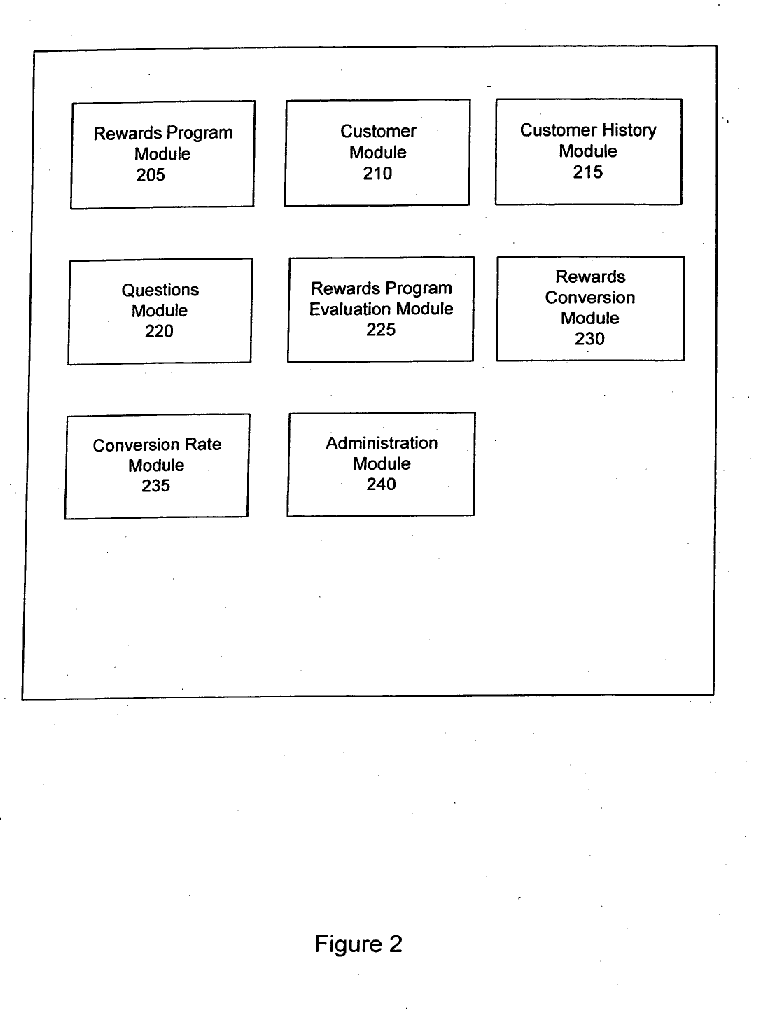

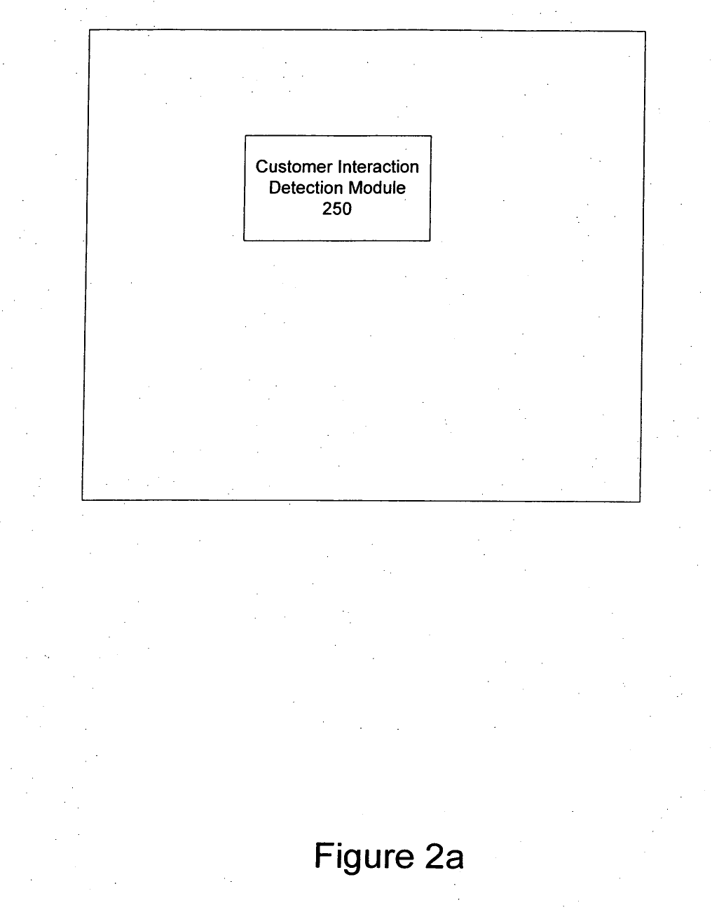

According to various embodiments, an agent of central rewards programs station 105 may interface with a graphical user interface (or GUI) to input: (1) data or information (e.g., terms, words, phrases, or digits) that enable the agent to define particular pools of customers, (2) data or information that enable the agent to define particular reward programs, (3) data or information that enable the agent define particulars about sponsors through which the reward programs will be delivered, (4) rules, parameters and algorithms used to identify which reward programs to present or offer to customers, and (5) particulars about converting rewards between various reward programs, including, for example, maintaining and updating conversion rates. An agent of central rewards program station 105 may also input information or data regarding how reward programs are stored (e.g., categorized) in a database 112, for example. Other modules may permit processing of the various features and functionality described herein for identifying and offering reward programs (See FIG. 2 for modules associated with central rewards program station 105).

Central rewards programs station 105 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

Data and information maintained by central rewards program station 105 may be stored and cataloged in database 112 which may comprise or interface with a searchable database. Database 112 may comprise, include or interface to a relational database. Other databases, such as a query format database, a Standard Query Language (SQL) format database, a storage area network (SAN), or another similar data storage device, query format, platform or resource may be used. Database 112 may comprise a single database or a collection of databases, dedicated or otherwise. In one embodiment, database 112 may store or cooperate with other databases to store the various data and information described herein. In some embodiments, database 112 may comprise a file management system, program or application for storing and maintaining data and information used or generated by the various features and functions of the systems and methods described herein. In some embodiments, database 112 may store, maintain and permit access to customer information, sponsor or reward program information, and general information used to identify and offer reward programs, as described herein.

Central rewards station 105 may, in some embodiments, be accessed via a communication network 107. Communications network 107 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34 bis analog modem connection, a cable modem, an Asynchronous Transfer Mode (ATM) connection, a Fiber Distributed Data Interface (FDDI) connection, or a Copper Distributed Data Interface (CDDI) connection.

Communications network 107 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 107 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network 107 may comprise a satellite communications network, such as a direct broadcast communication system (DBS) having the requisite number of dishes, satellites and transmitter/receiver boxes, for example. Communications network 107 may also comprise a telephone communications network, such as the Public Switched Telephone Network (PSTN). In another embodiment, communication network 120 may comprise a Personal Branch Exchange (PBX), which may further connect to the PSTN.

As shown in FIG. 1, issue or sponsor station 110 and card member station 115 may communicate central reward program station 105 via communication network 107. Issue or sponsor station 110 may comprise, for example, a station utilized by an agent of a card issuer or a sponsor to interact or communicate with card members. For example, station 110 may comprise a call center facility or station of card issuer or sponsor that is manned by an operator to receive calls from card members. In some embodiments, issue or sponsor station 110 may comprise or host web sites or web pages of the card issuer or sponsor that a card member can access to

Card member station 115 may, in some embodiments, enable a card member to interact with and communication a card issuer or sponsor as represented by issuer or sponsor station 110. For example, card member station 115 may enable a card member to call or access the web site or page of a card issuer or sponsor to inquire about account particulars, make payment on an account, or inquire about available balance, for example. In some embodiments, card member station 115 may comprise any terminal (e.g., a typical home or personal computer system) whereby a card member may interact with a network, such as the Internet or any data network, such as communications network 205, for example, responsible for transmitting and delivering data and information used by the various systems and methods described herein. Card member station 115 may comprise or include, for instance, a personal or laptop computer. Card member station 115 may include a microprocessor, a microcontroller or other general or special purpose device operating under programmed control. Card member station 115 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Card member station 115 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Card member station 115 may also include a network-enabled appliance, a browser-equipped or other network-enabled cellular telephone, or another TCP/IP client or other device.

FIG. 2 illustrates exemplary modules that may be associated with central rewards programs station 105 for carrying out (or administering) the various functions and features of the embodiments described herein. In some embodiments, the modules may: (1) be accessed by an agent or administrator of central rewards program station 105, (2) store, maintain and administer particulars on a plurality of rewards programs that are available to card members, (3) store, maintain and administer particulars on a plurality of card members, (4) track card member transactions with a plurality of reward cards and store, maintain and administer card member transaction histories for use in identifying reward programs, (5) store, maintain and administer questions to ask card members to better identify reward programs that may be of particular interest or relevant to a card member, (6) evaluate a card member's existing reward programs against alternative reward programs based on particulars about the card member, card member's transactions, or any other data or information that may demonstrate the user's needs, (7) convert rewards between reward programs, and (8) store, maintain and administer reward conversion rates. While the modules may not be used in all embodiments to perform some or all of the functions of the present invention, they are nonetheless presented as possible embodiments:

Rewards program module 205 may, in some embodiments, process and maintain data and information relating to reward programs that are available to card members. For example, reward programs may be stored and maintained by category, such as cash-back programs, proprietary programs (e.g., programs administered by the issuer of the card, loyalty programs (e.g., cards that are branded and reward loyalty to the sponsor), or any other type or category of reward programs that may be used to identify and offer reward programs according to the systems and methods described herein.

Customer module 210 may, in some embodiments, process and maintain data and information relating to customers of a card issuer or sponsor, such as, for example, the identity of the customer, the location (e.g., residential or work address) of the customer, the customer's preferred or favorite merchants, products or services, the card(s) associated with the customer, the reward programs associated with the customer, or any other biographical or demographic information that may be used to identify relevant reward programs to the customer according to the systems and methods described herein. In some embodiments, customer module 205 may cooperate with rewards program module 210 to associate particular customers with particular reward programs to enable the various systems and methods described herein to identify and offer reward programs that are relevant and of interest to card members.

Customer history module 215 may, in some embodiments, process and maintain data and information relating to card member transactions carried out via reward cards and/or reward programs. For example, customer history module 215 may, for a particular customer or card member, any and all transactions (e.g., purchases) that the card member has processed using a particular card, including the date of the transaction, the identity of the merchant or vendor, the amount of the transaction, the location of the transaction, the goods or services purchased, the reward value earned (e.g., redeemable points, cash, sponsor or issuer redeemable value), or any other data or information that may be used to classify the transaction in such a way that it may be used to identify and offer reward programs according to the systems and methods described herein. In some embodiments, customer history module 215 may also process and maintain data and information relating to card member reward redemptions carried out via reward cards and/or reward programs. For example, a card member that routinely redeems reward value for cash rather than for a particular product or service may indicate a preference for reward programs that offer cash over those that offer products or services.

Questions module 220 may, in some embodiments, process and maintain data and information relating to questions that may be used to further ascertain a card member's particular needs or desires in connection with reward programs. For example, a call center operator of a card issuer or sponsor, for example, may pose select questions to a card member in an effort to better determine the card member's preferences, needs or areas of interest. In some embodiments, the particular questions to ask may be presented on the call center operator's screen or monitor and may be determined based on particulars of the card member, such as the card member's identity, transaction history or reward program history (e.g., redemption history, reward earnings history, earning levels, reward categories, currency type (e.g., points, miles or cash), or any other particular related to a reward program), stated interest and any other data or information that may be used to identify questions of relevance. For example, a call center agent may be handling a call from a card member who called to inquire about the balance on his credit card. In pulling up the card member's account, the call center operator may be presented with a list of questions that are related to particulars of the card member's account and transaction history or reward program history (e.g., redemption history, reward earnings history, earning levels, reward categories, currency type (e.g., points, miles or cash), or any other particular related to a reward program). For example, if the card member's transaction history demonstrates that the card member is a frequent shopper at a particular video rental franchise, questions module 220 may process this information and generate a list of questions that may be posed to the card member to confirm or further ascertain the card member's preferences. Similarly, the card member's reward program history (e.g., redemption history, reward earnings history, earning levels, reward categories, currency type (e.g., points, miles or cash), or any other particular related to a reward program). For example, the history of value redemption associated with the card reward program or other reward program(s)) may indicate a preference for particular rewards. For example, questions module 220 may present the call center operator with the following questions: (1) “I see from your transaction history that you repeatedly rent (or redeem value for) videos, is that correct?”, and (2) “Would you be interested in a rewards program that offers discounted purchases (or free rentals) at the local video rental franchise?” The call center may then proceed to read the questions off to the card member and thereafter continue with offering the card member relevant reward programs. In some embodiments, questions module 220 may present the questions on the card member's screen or monitor, such as when the card member is accessing his account online, or may instead read the questions to the card member, such as when the card member is interacting with an interactive voice response (IVR) system.

Rewards program evaluation module 225 may, in some embodiments, evaluate a card member's particulars and identify and offer rewards programs that may be of particular interest or relevance to the card member. In some embodiments, card member particulars may comprise customer information, transaction history or reward program history (e.g., redemption history, reward earnings history, earning levels, reward categories, currency type (e.g., points, miles or cash), or any other particular related to a reward program), merchant or vendor information, and any information or data that may be used to identify relevant reward programs as described herein. In some embodiments, upon receiving a card member request (e.g., call in), contacting the card member (e.g. via phone or mail), or detecting card member interaction (e.g., attempt to pay bill online or via call center) via customer interaction detection module 250 (shown in FIG. 2a), rewards program evaluation module 225 may resolve card member particulars against rules or algorithms that correlate such card member particulars against reward programs maintained by rewards program module 205 to identify particular reward programs that may be of particular relevance or interest to the card member. In some embodiments, some or all of the reward programs available for offering may be administered by the administrator of central rewards programs station 105 (e.g., card issuer or sponsor), while in some embodiments some or all of the reward programs may be administered by a third party.

Rewards conversion module 230 may, in some embodiments, convert between rewards associated with various rewards program, or credit value to reward programs. For example, if a card member opts to switch to a new rewards program, rewards conversion module 230 may convert any rewards that have been accumulated by the card member in the current rewards program to the equivalent reward(s) in the new reward program the card member has switched to. In some embodiments, the conversion may be one-to-one, such that 100 reward value units (e.g., points), for example, in the initial rewards program will translate into 100 reward value units (e.g., points) in the new reward program. In some embodiments, a particular conversion rate may be referenced to calculate the appropriate translation of rewards. For example, reward program A may have a one-to-two ratio conversion with program reward B. Accordingly, if the card member had accumulated 100 value units (e.g., points) in program A, he would obtain 200 value units (e.g., points) for switching to program B. In some embodiments, rewards conversion module 230 may credit value to a reward program according the various systems and methods described herein. Other scenarios are possible.

Conversion rate module 235 may, in some embodiment, facilitate the rewards conversion process customer transactions by storing and maintaining conversion rates between various reward programs. This way, rewards conversion module 230 may readily obtain conversion rate information when needed. In some embodiments, conversion rates administered my conversion rate module 235 may be administered and revised by an agent of central rewards program station 105, for example.

Administration module 240 may, in some embodiments, enable an administrator of central rewards program station 105, for example, to interact with the various modules, features and functionality described herein. For example, an agent of central rewards program station 105 may interact with administration module 240 to input, revise and remove data and information used by the various systems and methods described herein, such as, for example, card member information, reward program information, conversion rate information, or any other data or information that may be used to identify and offer reward programs to customers as described herein. In some embodiments, administration module 240 may enable an administrator of central rewards station 105 to establish parameters or rules associated with the various features and functionality described herein. For example, an administrator may establish limits, caps, delays, vintage reward rules (e.g., vintage reward rule(s) may be established that specifies how aged rewards are to be treated—for example, a reward that has been in effect for two years may automatically expire; other rules may of course be established depending on specific business needs) or fees associated with a card member's use of the features and functionality described herein. Thus, a card member may be limited to a predetermined number of transactions (e.g., reward program switches) over a predetermined period of time, such as annually, for example. A card member may also be required to pay a fee to be able to be able to switch between reward programs. Such a fee may be annually imposed or may be charged on a one-time or per-transaction basis. In some embodiments, the fee may comprise a monetary amount or any other form of measurable value. In some embodiments, delays may be imposed to verify that a particular exchange or movement of points was done properly and in good-faith (e.g., accrue points before they are actually available for redemption).

FIG. 2a illustrates a customer interaction detection module 250 for detecting customer interaction with any of the systems and methods described herein. In some embodiments, customer interaction detection module 250 may cooperate with a call center, for example, to detect incoming customer calls or outgoing calls to a customer (e.g., customer may call to make payment or check balance). In some embodiments, customer interaction detection module 250 may cooperate with a web server to detect customer interaction with a web site (e.g., customer may access web site to make payment or check balance). In some embodiments, customer interaction detection module 250 may cooperate with a mail system to detect customer incoming or outgoing customer mailings (e.g., incoming payments made by mail may be detected.) In some embodiments, customer interaction detection module 250 may detect customer interaction with system 100 (e.g., central rewards programs station 105), or with any other internal or external systems or modules (proprietary or third party) that may process any aspect of reward program features or functionality.

In some embodiments, customer interaction detection module 250 may detect customer interaction and further conduct an analysis of interaction content or purpose and particulars thereof. For example, customer interaction detection module 250 may detect customer interaction with a web site and thereafter determine that it is for the purpose of conducting a balance transfer and the exact amount thereof. In some embodiments, information or data gleaned by customer interaction detection module 250 may be used by the various systems and methods described herein to identify and propose relevant reward programs. For example, if the customer is transferring 150 dollars (or points) away from his or her account with a first bank, for example, customer interaction detection module 250 may inform central rewards programs station 105 of this occurrence, and the latter may then propose relevant reward programs according the systems and methods described herein to encourage the customer to keep his or her money with the first bank. Similarly, if a customer is interacting with an external points management system (e.g., Points.com), customer interaction detection module 250 may scrape data or information available at the external points management system which relates to the customers associated reward programs. In some embodiments, the data or information scraped may comprise transaction history or reward program history (e.g., redemption history, reward earnings history, earning levels, reward categories, currency type (e.g., points, miles or cash), or any other particular related to a reward program) of the customer. The data or information obtained may then be used by the systems and methods described herein to propose relevant reward programs. For example, a customer transaction or reward program history with a particular competitor bank's card may result in central rewards programs station 105 generating questions or providing information to the customer on why their bank card and associated reward program(s) are better suited to the customer's needs. Other scenarios are of course possible.

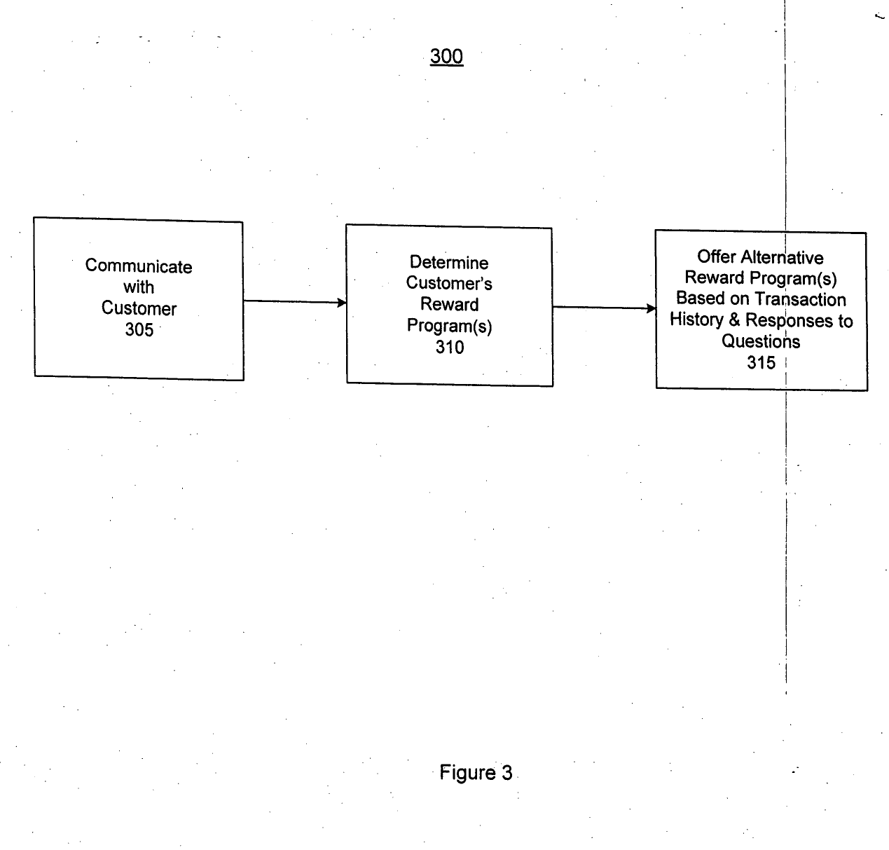

FIG. 3 illustrates a process flow 300 for identifying and offering reward programs, according to an embodiment of the systems and methods described herein. At step 305, a card-issuer or sponsor may communicate with a sponsor. Communication may occur in several ways. In some embodiments, communication may result from the card member calling the card-issuer, for example, to inquire about a balance or make payment on the account, for example. In some embodiments, the card member may access the card-issuer's web site to obtain information about the card and/or its services, or to otherwise interact with the card issuer on any matter associated with the card, such as, for example, making payment on the account or obtaining a credit line increase.

At step 310, the card member's current accounts, cards, reward program(s), and/or transactions history may be determined. For example, the call center operator may ask the card member for her account number and thereby determine particulars about the card, associated reward program(s), and past transaction history or reward program history (e.g., redemption history, reward earnings history, earning levels, reward categories, currency type (e.g., points, miles or cash), or any other particular related to a reward program). In some embodiments, central reward program station 105—in particular the various modules described in FIGS. 2 and 2a—processes the card member's account number (or other identifier, such as name, social security number, or other personal information, for example) and provides the call center operator with the information regarding the card member, his or her account and card, associated reward program(s), and any past transaction history or reward program history (e.g., redemption history, reward earnings history, earning levels, reward categories, currency type (e.g., points, miles or cash), or any other particular related to a reward program). In some embodiments, central reward program station 105 may automatically generate this information upon detecting card member interaction with any system of card-issuer, such as, for example, a web site were payments to the accounts are made.

At step 315, rewards program evaluation module 225 may then determine reward programs that may better suit the card member's needs or demonstrated interests. For example, if the user currently has a card that rewards value units (e.g., points) for purchases made at a particular retail outlet, which the card member rarely ever shops, reward program evaluation module 225 may identify another retail outlet that better fits the card member's demonstrated shopping patters. In some embodiments, questions module 220 may identify particular questions that may be presented to the card member to better refine the card member's interest and needs. In some embodiments, the questions identified by questions module 220 may be presented to the card member by a call center operator, by presenting them to the card member via a screen or monitor, such as when the card member is interactive with a web page of the card issuer, for example, or by presenting them through an IVR system or service. The card member respond to the questions as may be appropriate (e.g., responding to the call center agent, selecting icons on the issuer's web pate, or depressing keypads during a phone call). In some embodiments, the card member may unilaterally select the specific reward program(s) he or she is interested in joining, such as by interacting with particular tools provided by an issuing entity (e.g., a bank or other entity or individual that is administering reward program(s)), for example. In some embodiments, reward program(s) to be offered to the card member or customer may be identified based on the issuing entity's assessment of the user. Such assessment may comprise any factors or aspects of the user's relationship with the bank, transaction or reward program history that may be used to identify relevant reward programs.

In some embodiments, value may be switched between reward programs associated with different reward program entities. For example, an initial value to be converted may correspond to a rewards program administered by a first bank, while the switched or converted-to value may correspond to a rewards program administered by a second bank. In some embodiments, converting between such reward programs may involve interfacing with an internal or external “value” bank that maintains and administers value (e.g., points) balances associated with different reward programs with any number of reward program entities. For example, central rewards program station 105 administered by a first bank may interface with such a value bank to determine how much value a potential customer has with a rewards program administered by a second bank. The first bank may then use this information to determine the appropriate conversion rate, for example, or how to otherwise convert to value associated with one of its own reward programs. In some embodiments, access to the value bank may be controlled with appropriate security controls (e.g., username and password) to prevent fraud or unauthorized access to such data and information. Thus, a bank soliciting a potential client may access the value bank to verify the potential customer's value balance with a particular reward program associated with another bank, for example. In some embodiments, central rewards program station 105 may also deduct the value (e.g., points) associated with the other bank's reward program to ensure that the potential customer does not subsequently redeem the value with the other bank. In some embodiments, access to the value bank may require appropriate contractual relations with the administer of the value bank, the potential customer, and/or the entity program administering the potential customer's reward program to ensure proper authorized access to such information. In some embodiments, the value bank may also be used to convert value units (e.g., points) between reward programs associated with a single reward entity.

In some embodiments, a first bank soliciting a potential customer may offer the potential customer twice the reward being offered by the potential customer's reward's program. In some embodiments, the first bank may require that the potential customer first redeem his or her accumulated value with the second bank and submit it to the first bank once it is received. For example, the potential customer may redeem accumulated value earned through the second bank for a designated award, and then submit the award to the first bank for enrollment in a rewards program associated with the first bank. Enrollment in the first bank's rewards program may involve doubling the potential customer's reward that was redeemed through the second bank. For example, if the customer redeems accumulated value for a reward of $100 (check, coupon or cash), the first bank may require that the potential customer forward the reward to it in exchange for a doubling of the reward (e.g., $200 check, coupon or cash) if the potential customer terminates his or her relationship with the second bank and enrolls in the rewards program associated with the first bank. In some embodiments, the potential customer may also be required to provide evidence that his or relationship with the second bank has been terminated before receiving the inducement reward from the first bank. For example, the potential customer may be required to provide the first bank with a termination letter indicating that the customer's account with the second bank has been closed. Other inducement schemes are of course possible.

In some embodiments, the various systems and methods described herein may be used to pool value accumulated through a plurality of reward programs and transfer them to any number of reward programs. For example, a customer having 100 value units (e.g., points) accumulated on a theme-park card, 50 value units (e.g., points) on an airline card, and 25 value units (e.g., points) on a gas station card, may transfer some or all of the accumulated value onto a single rewards program or any number of rewards programs. Thus, the 150 points associated with the theme-park and airline cards may be converted and transferred onto the gas station card. In another example, the 50 points associated with the airline card may be transferred to the theme-park and gas station cards in equal (e.g., 25 and 25) or other predetermined amounts (e.g., 35 for the theme-park card and 15 for the gas station card). In some embodiments the collective 150 points may be credited onto a new reward program. For example, the 150 points may remain with the customer, but a new program may be created which credits rewards to the customer based on the 150 accumulated points. Other conversion and transfer schemes are of course possible.

In some embodiments, the various systems and methods described herein may be transfer accumulated value (e.g., points) from one individual to another, regardless of the reward programs involved. For example, person A may have 100 points accumulated with reward program A. Person A may transfer 50 of his points, for example, to Person B who is associated with rewards program B. In some embodiments, accumulated points may also be transferred to specific individuals within a rewards program. For example, a father enrolled in a rewards program associated with a gas card and having 100 points of value, for example, may designate that 25 points be transferred to his daughter and that 25 points be transferred to his son. In some embodiments, the transferred points may be stored in or associated with a sub-account associated with the rewards program and/or the transferee (e.g., son and daughter).

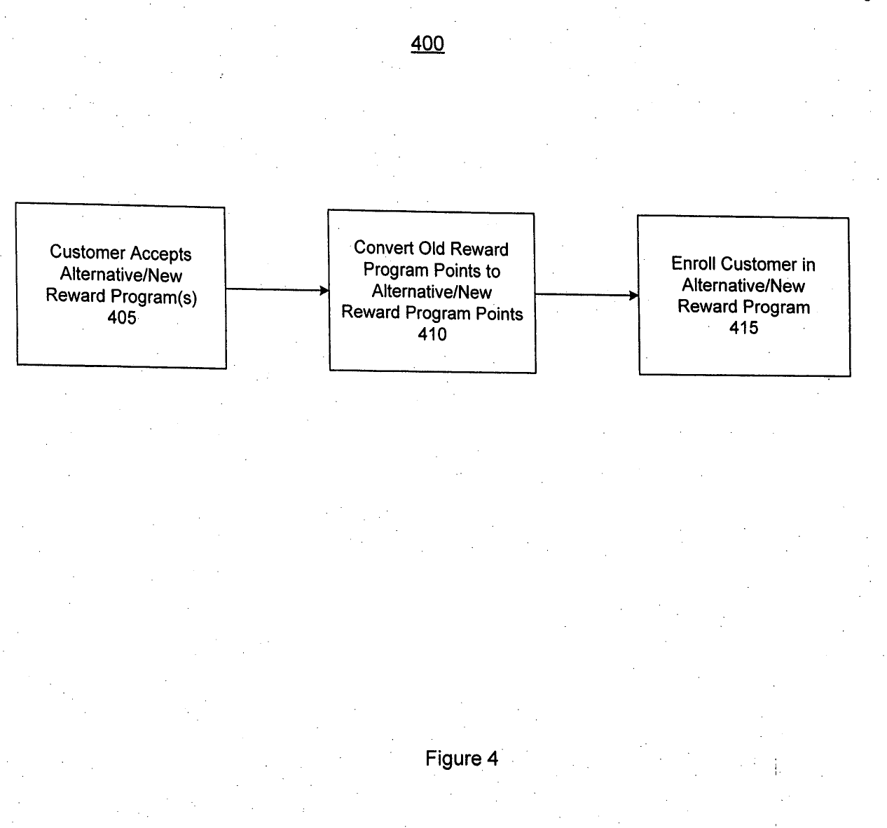

FIG. 4 illustrates a process flow 400 for converting rewards between reward programs, according to an embodiment of the systems and methods described herein. At step 405, the card member of FIG. 3 may opt to switch to the offered reward program. At step 410, rewards conversion module 230 may determine whether the card member has accumulated any reward value with the current rewards program. If so, then rewards conversion module may determine the reward value earned and interface with conversion rate module 235 to determine the appropriate conversion rate rewards conversion module may then store or associate the converted rewards with the card or account of the card member and enroll the card member in the new rewards program.

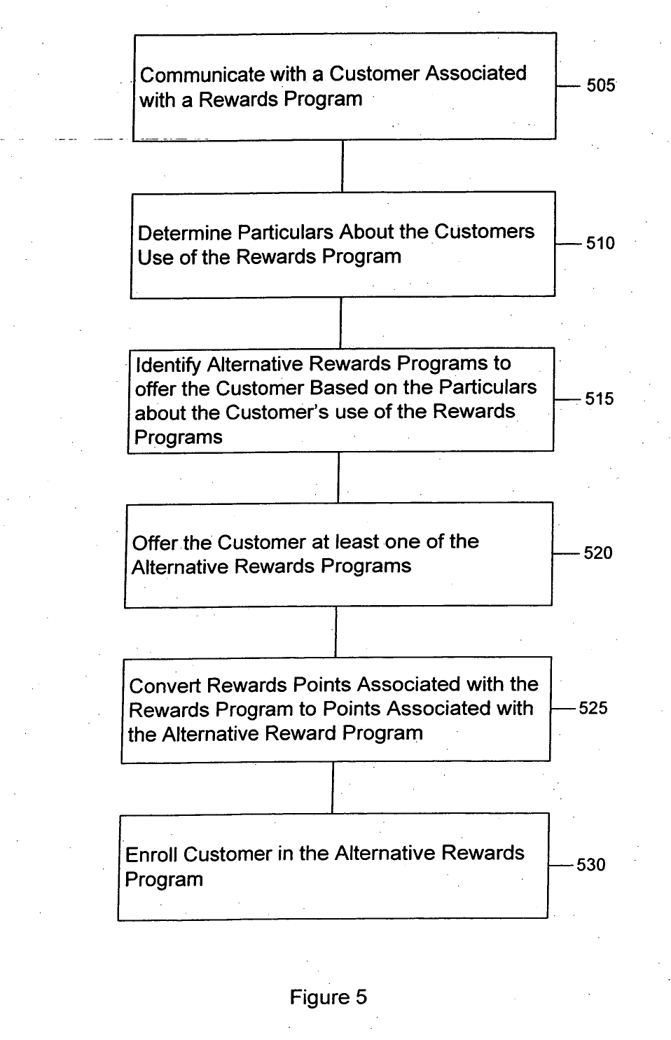

FIGS. 5, 6 and 7 generally illustrate typical process flows performed by the systems described herein for identifying and offering rewards programs:

FIG. 5 illustrates a process flow 500 for identifying and offering at least one reward program, according to various embodiments of the systems and methods described herein. At step, 505 a card issuer or sponsor may communicate with a customer. At step 510, particulars about the customer's use of the rewards program may be determined, such as past transactions with the card. At step 515, alternate rewards programs may be determined based on particulars about the customer's use of the card and/or his rewards programs. At step 520, the customer may be offered any of the alternative rewards programs. At step 525, rewards earned by the customer with the initial rewards program may be converted to rewards associated with the alternative reward program(s) selected by the card member. At step 530, the card member may be enrolled in the alternative rewards program.

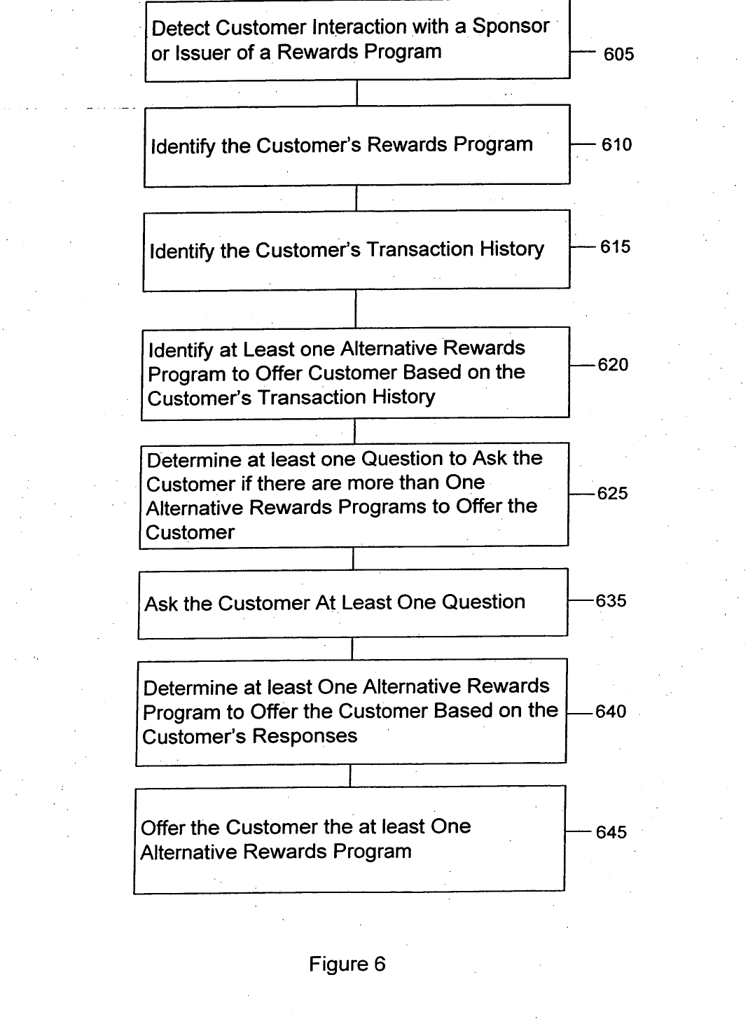

FIG. 6 illustrates a process flow 600 for identifying and offering at least one reward program. At step 605, card member interaction with a sponsor or issuer of a card or rewards program may be detected. At step 610, particulars of the customer's card or reward program may be identified. At step 615, the card member's transaction history and/or reward program history (e.g., redemption history, reward earnings history, earning levels, reward categories, currency type (e.g., points, miles or cash), or any other particular related to a reward program) may be determined. At step 620, at least one alternative rewards program to offer the card member may be identified based on the card member's demonstrated transaction or redemption histories. At step 625, at least one question to ask the card member may be identified. In some embodiments, the at least one question may be identified if there are more than one alternative reward programs that may be of interest to the card member. The questions may help determine which alternative rewards program is best suited for the card member. At step 630, the identified questions may be asked. At step 630, the at least one question may be asked. At step 635, at least one alternative rewards program is selected to be offered to the card member based on the card member's response to the questions. At step 640, the at least one alternative rewards program is offered tot the card member.

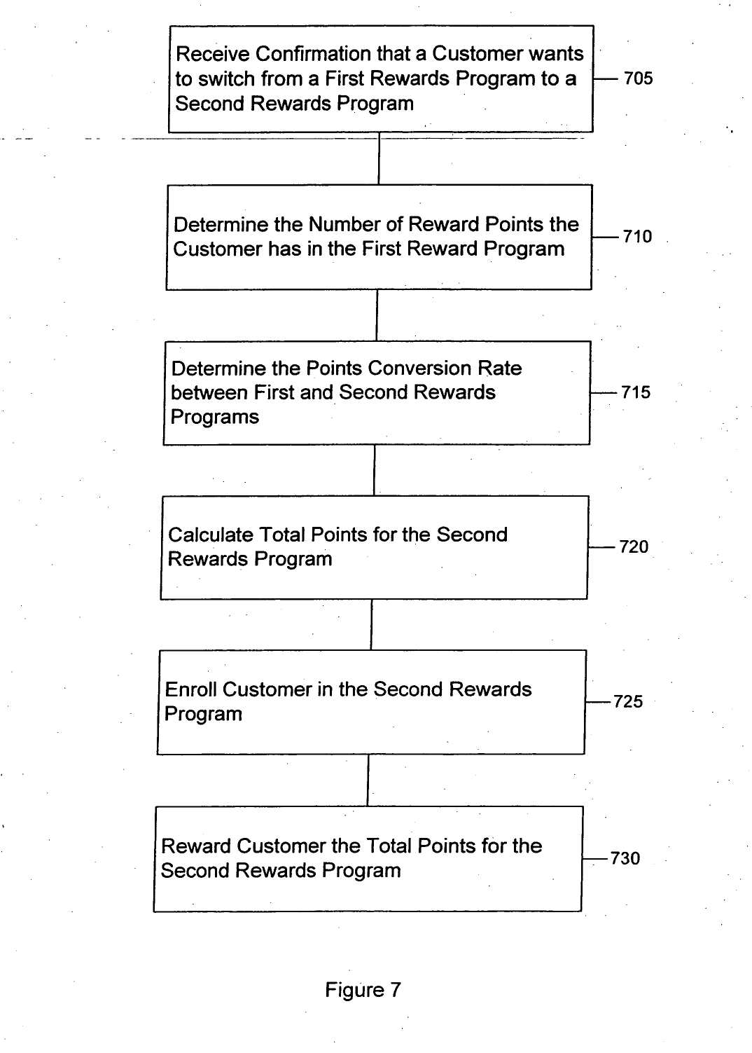

FIG. 7 illustrates a process flow 700 for identifying and offering reward programs, according to various embodiments of the invention. At step 705, confirmation that a customer wants to convert from a first rewards program to a second rewards program may be received. At step 710, the number of reward points the customer has in the first rewards program is determined. At step 715, the rewards conversion rate between the first and second rewards program may be determined. At step 720, the total points for the second rewards program may be calculated. At step 725, the customer may be enrolled in the second rewards program. At step 730, the customer may be rewarded the second reward program rewards.

The embodiments of the present inventions are not to be limited in scope by the specific embodiments described herein. For example, although many of the embodiments disclosed herein have been described with reference to rewards programs, the principles herein are equally applicable to the any type of program, rewards or otherwise, that may enroll customer or users. In addition, although many of the embodiments disclosed herein have been described with reference to a central rewards program station that is associated with a card issuer, such as a bank, for example, it should be appreciated that various aspects of the invention may be accomplished when various system components are located elsewhere. For instance, the central rewards program station described herein may be maintained and administered by a third party service provider. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

What is claimed is:

1. A method for identifying and offering reward programs, comprising the steps of:
determining at least one rewards program associated with a user;
determining at least one alternative reward program to offer the user based on the user's selection, demographics, responses to a questionnaire, transaction history, or reward program history;
offering the user the opportunity to enroll in the alternative rewards program; and
converting rewards associated with the at least one rewards program to rewards associated with the at least one alternative reward program if the user accepts the offer to the enroll.

2. The method of claim 1 wherein the at least one alternative reward program is associated with a first reward card.

3. The method of claim 1 wherein the at least one alternative reward program is associated with a second reward card.

4. The method of claim 1 wherein the rewards comprise redeemable points.

5. The method of claim 1 wherein the rewards comprise cash value.

6. The method of claim 1 wherein the rewards are issuer-specific or sponsor-specific.

7. The method of claim 6 wherein the issuer-specific or sponsor-specific exchange entity comprises any redeemable value.

8. The method of claim 1 wherein determining at least one rewards program associated with the user comprises receiving account information associated with the at least one reward program from the user.

9. The method of claim 1 wherein the user's at least one rewards program is determined upon detecting user interaction with an issuer or sponsor.

10. The method of claim 1 wherein the questionnaire comprises at least one question.

11. The method of claim 1 wherein the at least one question is based on the user's biographic, demographic, or transaction history or reward program history.

12. A method for identifying and offering reward programs, comprising the steps of:
determining at least one rewards program associated with a user;
determining the user's transaction history or reward program history with the rewards program;
determining at least one alternative reward program to offer the user based on the user's transaction history or reward program history;
offering the user the opportunity to enroll in the alternative rewards program; and
converting or crediting rewards associated with the at least one rewards program to rewards associated with the at least one alternative reward program if the user accepts the offer to the enroll.

13. A system for offering or marketing reward programs, comprising the steps of:
a detection module for detecting user interaction with an issuer or sponsor of a rewards card or account.
a rewards program module for determining at least one rewards program associated with the reward card or account or the user of the reward card or account;
a customer history determination module for determining the user's transaction history or reward program history with the rewards card or account;
a rewards program evaluation module for determining at least one alternative reward programs to offer the user based on the user's transaction history or reward program history; and
a conversion module for converting or crediting rewards associated with the at least one rewards program to rewards associated with the at least one alternative reward program if the user accepts an offer to the enroll in the alternative reward program, wherein the conversion is based on a conversion rate stored and maintained by a conversion rate module.

14. The system of claim 13 wherein the detection module detects the user's attempt to pay an invoice associated with the rewards card or account or any other card or account associated with the user.

15. The system of claim 13 wherein the detection module detects the user's request for a balance associated with the rewards card or account or any other card or account associated with the user.

16. The system of claim 13 wherein the at least one alternative reward program is associated with the first reward card or account.

17. The system of claim 13 wherein the at least one alternative reward program is associated with a second reward card or account.

18. The system of claim 13 wherein the rewards comprise redeemable points.

19. The system of claim 13 wherein the rewards comprise cash value.

20. The system of claim 13 wherein the rewards comprise a card or account issuer-specific or sponsor-specific exchange entity.

21. The system of claim 20 wherein the card issuer-specific or sponsor-specific exchange entity comprises any redeemable value.

22. The system of claim further comprising a questions module for storing and administering questions to ask the at least one customer, wherein the customer's responses to the questions are used to identify reward programs that are of interest to the customer

23. A system for identifying and offering reward programs, comprising:
a rewards program module for storing and administering particulars of a plurality of reward programs including at least one reward program associated with at least one customer;
a customer module for storing and administering particulars of a plurality of customers including the at least one customer, wherein the at least one customer is associated with at least one reward card that is associated with the at least one reward program;
a customer history module for tracking, storing and administering particulars of the at least one customer's transaction history or reward program history with the at least one reward card;
a questions module for storing and administering questions to ask the at least one customer, wherein the customer's responses to the questions are used to identify reward programs that are of interest to the customer;
a rewards program evaluation module for determining at least one alternative reward program that may be of interest to the user based on biographical or demographic data or information about the customer, the customer's transaction history or reward program history with the at least one reward card, or the customer's responses to the questions; and
a conversion module for converting or crediting rewards associated with the at least one rewards program to rewards associated with the at least one alternative reward program if the user accepts an offer to the enroll in the alternative reward program, wherein the conversion is based on a conversion rate stored and maintained by a conversion rate module.

24. A method for identifying and offering reward programs, comprising the steps of:
determining at least one rewards program associated with a user;
determining at least one alternative reward program to offer the user based on an issuing entity's assessment of the user;
offering the user the opportunity to enroll in the alternative rewards program; and
converting or crediting rewards associated with the at least one rewards program to rewards associated with the at least one alternative reward program if the user accepts the offer to the enroll.
